(19) United States
(12) Patent Application Publication
(10) Pub. No.: US 2025/0210231 A1
(43) Pub. Date: Jun. 26, 2025

(54) TWISTED PAIR CABLE HAVING AN ENHANCED ALIEN CROSSTALK MITIGATION PORTION STRUCTURALLY CONFIGURED TO REDUCE ALIEN CROSSTALK

(71) Applicant: BELDEN CANADA ULC, 2310 Alfred-Nobel (CA)

(72) Inventors: VIRAK SIEV, Montreal (CA); MICHAEL BODZAY, Dollard-des-Ormeaux (CA)

(73) Assignee: BELDEN CANADA ULC, 2310 Alfred-Nobel (CA)

(21) Appl. No.: 18/984,319

(22) Filed: Dec. 17, 2024

Related U.S. Application Data
(60) Provisional application No. 63/613,679, filed on Dec. 21, 2023.

(51) Int. Cl. H01B 11/08

(52) U.S. Cl. CPC H01B 11/08

(57) ABSTRACT

A twisted pair cable provides reduced alien crosstalk from an adjacent twisted pair cable. The twisted pair cable may include a conductor portion and an enhanced alien crosstalk mitigation portion. The enhanced alien crosstalk mitigation portion may comprise a first end portion and a second end portion. The first end portion of the enhanced alien crosstalk mitigation portion may include a folded portion folded back toward an outer surface of the enhanced alien crosstalk mitigation portion. The folded portion includes an inner fold portion and the first end portion. The inner fold portion may provide a layer of the enhanced alien crosstalk mitigation portion between the first and second end portions and the conductor portion to reduce alien crosstalk between the twisted pair cable and an adjacent twisted pair cable.

### CROSS REFERENCE TO RELATED APPLICATION

This application claims the benefit of U.S. Provisional Application No. 63/613,679 filed Dec. 21, 2023, which is currently pending, the disclosure of which is hereby incorporated by reference herein in its entirety.

### TECHNICAL FIELD

The present disclosure generally relates to a twisted pair cable. More specifically, the disclosure relates to such a twisted pair cable with balanced alien crosstalk.

### BACKGROUND

Some twisted pair cables have been designed with a floating shield cable construction. Such twisted pair cables may include one or more pair of central conductors with a shield wrapped around the twisted pair(s). However, the shield on such a twisted pair cable may cause problems such as edge coupling between the twisted pair and an edge of the wrapped shield. The coupling may cause degradation in the cables ability to transmit data signals.

High-bandwidth data cable standards established by industry standards organizations including the Telecommunications Industry Association (TIA), International Organization for Standardization (ISO), and the American National Standards Institute (ANSI) such as ANSI/TIA-568.2-D, include performance requirements for cables commonly referred to as Category 6A type. These high-performance Category 6A cables have strict specifications for maximum return loss and crosstalk, amongst other electrical performance parameters. Failure to meet these requirements means that the cable may not be usable for high data rate communications such as 10GBASE-T (10-Gigabit Ethernet), or other standards.

Crosstalk is the result of electromagnetic interference (EMI) between adjacent pairs of conductors in a cable, whereby signal flow in a first twisted pair of conductors in a multi-pair cable generates an electromagnetic field that is received by a second twisted pair of conductors in the cable and converted back to an electrical signal. Similarly, alien crosstalk is electromagnetic interference between twisted pairs of conductors in adjacent cables. In typical installations with a large number of cables following parallel paths from switches and routers through cable ladders and trays, many cables with discrete signals may be in close proximity and parallel for long distances, increasing alien crosstalk. Alien crosstalk is frequently measured via two methods: power sum alien near end crosstalk (PSANEXT) is a measurement of interference generated in a test cable by a number of surrounding interfering or “disturbing” cables, typically six, and is measured at the same end of the cable as the interfering transmitter; and power sum alien attenuation to crosstalk ratio, far-end (PSAACRF), which is a ratio of signal attenuation due to resistance and impedance of the conductor pairs, and interference from surrounding disturbing cables.

Typical methods for addressing alien and internal crosstalk have tradeoffs. For example, alien crosstalk may be reduced by increasing the size of the cable, adding weight and volume and reducing the number of cables that may be placed in a cable tray. Other cables have implemented complex discontinuous EMI barriers and tapes in an attempt to control alien crosstalk and ground current disruption but add significant expense and may actually increase alien crosstalk in some implementations. Fully shielded cables, such as foil over unshielded twisted pair (F/UTP) designs include drain wires for grounding a conductive foil shield but are significantly more expensive in total installed cost with the use of shielded connectors and other related hardware. Fully shielded cables are also more difficult to terminate and may induce ground loop currents and noise if improperly terminated.

However, the twisted pair cables using such methods to address alien crosstalk provide cables that may provide undesired levels of alien crosstalk from an adjacent twisted pair cable.

It may therefore be desirable to provide a twisted pair cable that includes an enhanced alien crosstalk mitigation portion that is configured to reduce or mitigate alien crosstalk from an adjacent twisted pair cable.

### SUMMARY

According to embodiments of the disclosure, a twisted pair cable reduces alien crosstalk from an adjacent twisted pair cable. The twisted pair cable may include a conductor portion, an enhanced alien crosstalk mitigation portion that is structurally configured to surround the conductor portion and a positioning portion disposed adjacent to the conductor portion. The enhanced alien crosstalk mitigation portion may comprise a barrier portion. The barrier portion may comprise an inner layer and an outer layer. The inner layer may comprise a non-conductive layer and the outer layer may comprise a conductive layer. The barrier portion may comprise a first end portion and a second end portion configured to extend along a length of the twisted pair cable. The barrier portion may be configured to be wrapped around the conductor portion and the positioning portion such that the second end portion is positioned adjacent to and overlaps the first end portion. The barrier portion may include a folded portion that is folded back toward an outer surface of the barrier portion such that the folded portion includes an inner fold portion and an outer fold portion. The outer fold portion may include the first end portion. The inner fold portion of the barrier portion may be configured to be affixed to the positioning portion such that the barrier portion is fixedly positioned relative to the positioning portion. The inner fold portion may be configured to provide a layer of the barrier portion between the conductor portion and the first and second end portions of the barrier portion so as to reduce an alien crosstalk between the twisted pair cable and an adjacent twisted pair cable.

According to embodiments of the disclosure, a twisted pair cable reduces alien crosstalk from an adjacent twisted pair cable. The twisted pair cable may include a conductor portion and an enhanced alien crosstalk mitigation portion structurally configured to surround the conductor portion. The enhanced alien crosstalk mitigation portion may comprise a barrier portion. The barrier portion may comprise a first end portion and a second end portion configured to extend along a length of the twisted pair cable. The barrier portion may configured to be wrapped around the conductor portion such that the second end portion is positioned adjacent to and overlaps the first end portion. The barrier portion may include a folded portion that is folded back toward an outer surface of the barrier portion such that the folded portion includes an inner fold portion and an outer fold portion. The outer fold portion may include the first end portion. The inner fold portion may be configured to provide a layer of the barrier portion between the conductor portion and the first and second end portions of the barrier portion so as to reduce alien crosstalk between the twisted pair cable and an adjacent twisted pair cable.

According to embodiments of the disclosure, a twisted pair cable provides reduced alien crosstalk from an adjacent twisted pair cable. The twisted pair cable may include a conductor portion and an enhanced alien crosstalk mitigation portion. The enhanced alien crosstalk mitigation portion may comprise a first end portion and a second end portion. The first end portion of the enhanced alien crosstalk mitigation portion may include a folded portion folded back toward an outer surface of the enhanced alien crosstalk mitigation portion. The folded portion includes an inner fold portion and the first end portion. The inner fold portion may provide a layer of the enhanced alien crosstalk mitigation portion between the first and second end portions and the conductor portion to reduce alien crosstalk between the twisted pair cable and an adjacent twisted pair cable.

### BRIEF DESCRIPTION OF THE DRAWINGS

Further advantages and features of the present disclosure will become apparent from the following detailed description and the accompanying drawings.

FIG. 1 illustrates a twisted pair cable in accordance with various aspects of the disclosure.

FIG. 2 illustrates a barrier tape of a twisted pair cable in accordance with various aspects of the disclosure.

FIG. 3 illustrates a barrier tape of a twisted pair cable in accordance with various aspects of the disclosure.

FIG. 4 illustrates a twisted pair cable in accordance with various aspects of the disclosure.

### DETAILED DESCRIPTION

Reference will now be made in detail to presently preferred embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure. Furthermore, the terminology used herein is used only for the purpose of describing particular embodiments of the present disclosure and is not intended to be limiting in any way.

As used in the specification and the appended claims, the singular form “a,” “an,” and “the” include plural referents unless the context clearly indicates otherwise. For example, reference to a component in the singular is intended to also include a plurality of components.

The present disclosure addresses problems of cable to cable or “alien” crosstalk (ANEXT) in a cost-effective manner, without the larger, stiffer, more expensive, and harder to consistently manufacture design tradeoffs of typical cables. In particular, the methods of manufacture and cables disclosed herein reduce external cable ANEXT coupling noise (alien crosstalk), meeting American National Standards Institute (ANSI)/Telecommunications Industry Association (TIA) 568 Category 6A (Category 6 Augmented) specifications via the disclosed design methodologies.

Embodiments disclosed herein include a barrier tape around a twisted-pair cable comprising one or more pairs of unshielded twisted pair (UTP) conductors that may include a filler ensuring dimensional stability for improved internal cable electrical performance. The barrier tape edge is configured to reduce ANEXT (alien crosstalk) from an adjacently placed twisted-pair cable, as further described herein.

In some embodiments, the barrier tape may comprise an electrically continuous electromagnetic interference (EMI) barrier tape, used to mitigate ground interference in the design. In some embodiments, the tape may not include a drain wire and may be left unterminated or not grounded during installation. The filler may be centrally located within the cable, with pairs of conductors in channels on opposite sides or between each arm of a cross formed by the filler.

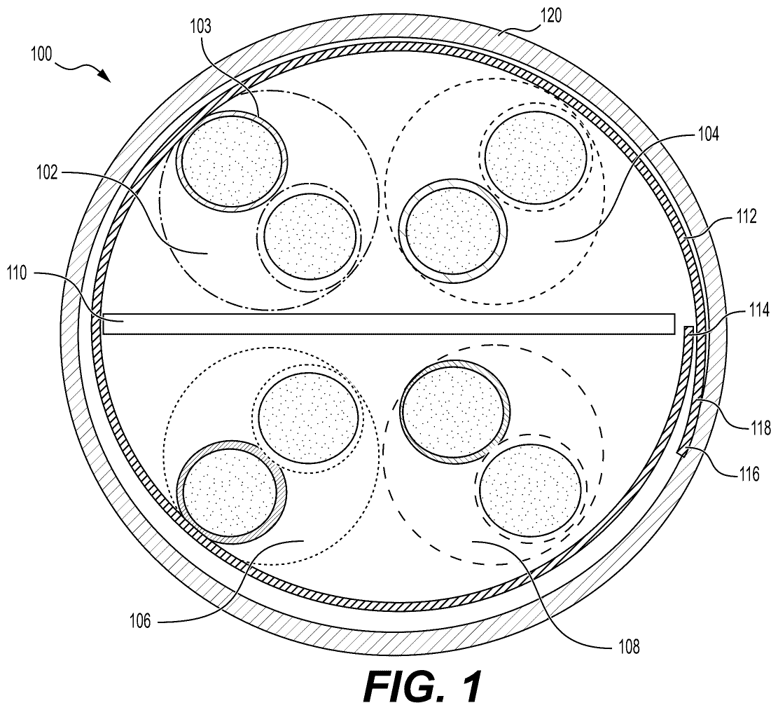

FIG. 1 illustrates an exemplary embodiment that may be used in conjunction with the aspects disclosed herein. In FIG. 1, a cross-section of a twisted pair cable 100 is illustrated. The cable 100 includes a plurality of twisted pairs of conductors 102, 104, 106, 108. Each of the conductors of the pairs 102, 104, 106, 108 may have an outer insulator. The conductors of the pairs 102, 104, 106, 108 may be of any suitable conductive material, such as copper. Although the embodiment of FIG. 1 illustrates four twisted pairs, any number of twisted pairs may be included within the cable.

In some embodiments, the cable 100 may include a filler 110. The filler 110 may be of a non-conductive material, such as flame-retardant polyethylene (FRPE) or any other such low loss dielectric material. The filler 110 may be of any size, depending upon the diameter of the conductors of pairs 102, 104, 106, 108.

In some embodiments, the cable 100 may include a multi-layer barrier tape 112. The barrier tape 112 may include two or more layers. The layers of the barrier tape 112 may include one or more conductive layers and one or more non-conductive layers. The barrier tape includes end portions 114, 116. The barrier tape 112 may be wrapped around the conductors 102, 104, 106, 108 so as to surround the conductors and the filler 110 (if included), with the end portions 114, 116 overlapping each other at an edge portion of the barrier tape 112. In some embodiments, the end portions 114, 116 may be connected to the end of the filler 110 so that the filler acts as a positioning element or portion such that the end portions of the barrier tape may be fixed in position within the cable.

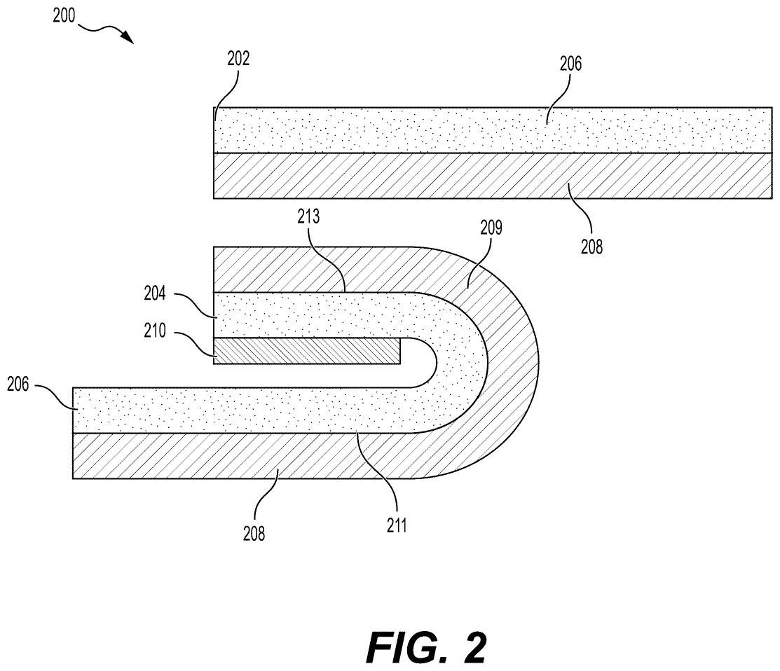

FIG. 2 illustrates a cross-sectional view of edge portions (overlapping end portions) of a barrier tape 200 as deployed when disposed around one or more twisted pairs of a twisted pair cable in accordance with various embodiments. For simplicity, the twisted pair conductors are not illustrated in FIG. 2 but could appear similar to the twisted pair conductors of FIG. 1, with any number of twisted pairs conductors included within the cable.

The barrier tape 200 may include end portions 202 and 204, a conductive layer 206 and a non-conductive layer 208. The conductive layer 206 may be a metallic layer such as an aluminum foil layer or any other suitable metallic material. The non-conductive layer 208 may be a polyester layer or other suitable non-conductive layer. One or more adhesive layers may also be included in the barrier tape between or on an outside of the layers. In the embodiment of FIG. 2, the conductive layer 206 is configured to face outward and the non-conductive layer is configured to face inward. The barrier tape 200 may include an additional non-conductive (insulating) layer 210 only on the last or outer portion of the end portion 204 to prevent electrical contact at the fold 209. The additional insulating layer may be formed either as part of the barrier tape construction or as a separate element that is added during cable manufacturing.

Additionally, embodiments disclosed herein may include folded portion 209. The folded portion 209 may include an inner fold portion 211 and an outer fold portion 213. The folded portion 209 may be an enhanced alien crosstalk mitigation portion configured to reduce alien crosstalk from an adjacent cable. The folded portion utilizes an additional layer of the barrier tape, the inner fold portion to be placed between the end portions 202 and 204 and the conductor portion so as to reduce or mitigate any alien crosstalk from an adjacent cable. In some embodiments, the folded portion functioning as the alien crosstalk mitigation portion is configured to reduce alien crosstalk by 3 dB or more.

In some embodiments, the folded portion 209 may be configured in a U shaped portion. The end portion 202 is configured to overlap the folded portion 209. The overlapping area of end portions 202, 204 created by the folded portion 209 reduces the coupling between the conductors and the end portions 202, 204 of the barrier tape 200.

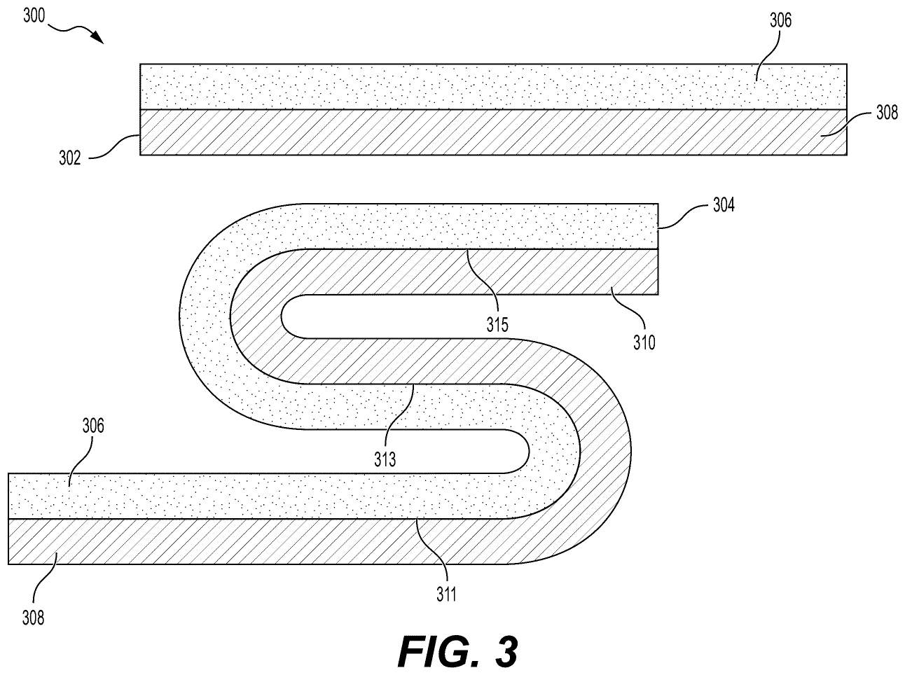

FIG. 3 illustrates a cross-sectional view of edge portions (overlapping end portions) of a barrier tape 300 as deployed when disposed around one or more twisted pairs of a twisted pair cable in accordance with various embodiments. For simplicity, the twisted pair conductors are not illustrated in FIG. 3 but could appear similar to the twisted pair conductors of FIG. 1, with any number of twisted pairs conductors included within the cable.

The barrier tape 300 may include end portions 302 and 304, a conductive layer 306 and a non-conductive layer 308. The conductive layer 306 may be a metallic layer such as an aluminum foil layer or any other suitable metallic material. The non-conductive layer 308 may be a polyester layer or other suitable non-conductive layer. One or more adhesive layers may also be included in the barrier tape 300 between or on an outside of the layers. In the embodiment of FIG. 3, the conductive layer 306 is configured to face outward and the non-conductive layer 308 is configured to face inward.

The end portion 304 of the barrier tape 300 may be folded over itself in a folded portion 310 into an S-shape. The folded portion 310 may include an inner fold portion 311, a middle fold portion 313 and an outer fold portion 315. The folded S-shape is configured to provide two additional layers of the barrier tape between the end portions 302, 304 and the conductor portion. The inner fold portion 311 and the middle fold portion 313 are configured to provide the additional layers of the barrier tape (enhanced alien crosstalk mitigation portion) between the conductor portion and the first and second end portions so as to reduce the alien crosstalk between the twisted pair cable and any adjacent twisted pair cable. In some embodiments, the folded portion 310 functioning as the alien crosstalk mitigation portion is configured to reduce alien crosstalk by 3 dB or more.

The barrier tape 300 may include an additional non-conductive (insulating) layer only folded portion 310 of the end portion 304 to prevent electrical contact at the fold. The additional insulating layer may be formed either as part of the barrier tape construction or as a separate element that is added during cable manufacturing.

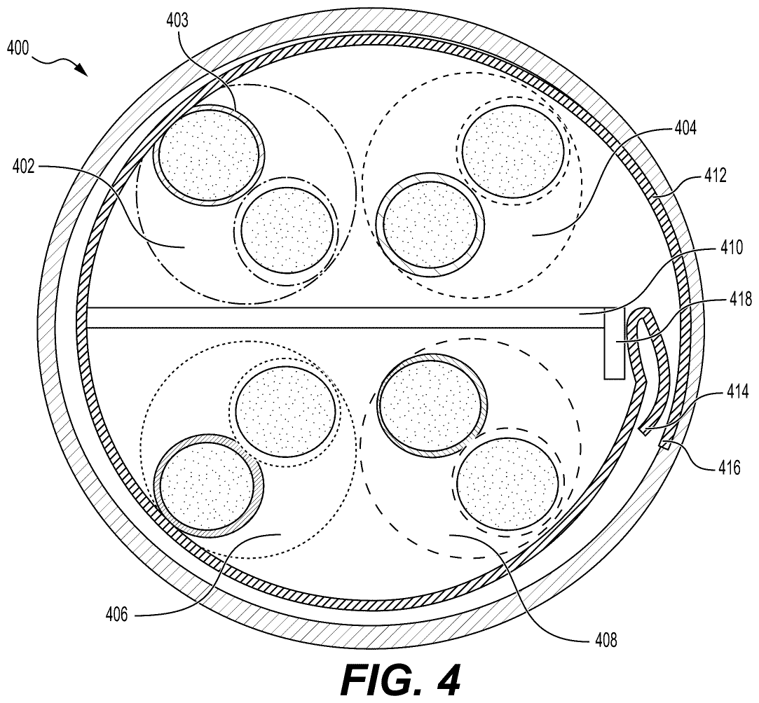

FIG. 4 illustrates a cross-sectional view of a twisted pair cable 400. The cable 400 may include a plurality of conductors 402, 404, 406, 408. Each pair of the conductors forms a twisted pair within the cable 400. Each of the conductors 402, 404, 406, 408 may have an outer insulator (not shown). The conductors 402, 404, 406, 408 may be of any suitable conductive material, such as copper. Although the embodiment of FIG. 4 illustrates four twisted pairs, any number of twisted pairs may be included within the cable 400.

In some embodiments, the cable 400 may include a filler 410. The filler 410 may be of a non-conductive material, such as flame-retardant polyethylene (FRPE) or any other such low loss dielectric material. The filler 410 may be of any size, depending upon the diameter of the conductors 402, 404, 406, 408.

In some embodiments, the cable 400 may include a barrier tape 412. The barrier tape 412 may be a multi-layer barrier tape that may include two or more layers. The layers of the barrier tape 412 may include one or more conductive layers and one or more non-conductive layers. The barrier tape includes end portions 414, 416. The barrier tape 412 may be wrapped around the conductors 402, 404, 406, 408 and the filler 410, with the end portions 414, 416 overlapping each other at an edge portion of the barrier tape 412. In some embodiments, the end portion 414 may include a folded portion such as the folded portion 209 of FIG. 2 or the folded portion 310 of FIG. 3. In some embodiments, the folded portion functioning as the alien crosstalk mitigation portion is configured to reduce alien crosstalk by 3 dB or more.

The filler (positioning portion) 410 may have an extended end portion 418 configured with a length to move the end portions 414, 416 of the barrier tape 412 farther from the twisted pairs of conductors 402, 404, 406, 408 of the cable 400. In various embodiments, the filler may move the end portions 414, 416 approximately 2 mm farther from the conductors, for example. The filler portion may be configured to attach to the barrier tape 412 to position the barrier tape within the cable.

While multiple non-limiting embodiments have been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A twisted pair cable configured to reduce alien crosstalk from an adjacent twisted pair cable, comprising:
a conductor portion;
an enhanced alien crosstalk mitigation portion that is structurally configured to surround the conductor portion;
a positioning portion disposed adjacent to the conductor portion;
wherein the enhanced alien crosstalk mitigation portion comprises a barrier portion;
wherein the barrier portion comprises an inner layer and an outer layer;
wherein the inner layer comprises a non-conductive layer and the outer layer comprises a conductive layer;
wherein the barrier portion comprises a first end portion and a second end portion configured to extend along a length of the twisted pair cable;
wherein the barrier portion is configured to be wrapped around the conductor portion and the positioning portion such that the second end portion is positioned adjacent to and overlaps the first end portion;
wherein the barrier portion includes a folded portion that is folded back toward an outer surface of the barrier portion such that the folded portion includes an inner fold portion and an outer fold portion;
wherein the outer fold portion includes the first end portion;
wherein the inner fold portion of the barrier portion is configured to be affixed to the positioning portion such that the barrier portion is fixedly positioned relative to the positioning portion; and
wherein the inner fold portion is configured to provide a layer of the barrier portion between the conductor portion and the first and second end portions of the barrier portion so as to reduce an alien crosstalk between the twisted pair cable and an adjacent twisted pair cable.

2. The twisted pair cable of claim 1, wherein the folded portion is configured in a U shape to provide the additional layer of the barrier portion between the conductor portion and the first and second end portions.

3. The twisted pair cable of claim 1, wherein the folded portion includes a middle fold portion between the inner fold portion and the outer fold portion, wherein the middle fold portion is configured to provide an additional layer of the barrier portion between the conductor portion and the first and second end portions of the barrier portion to reduce the alien crosstalk between the twisted pair cable and an adjacent twisted pair cable.

4. The twisted pair cable of claim 3, wherein the folded portion is configured in an S shape to provide the additional layer of the barrier portion between the conductor portion and the first and second end portions of the barrier portion.

5. The twisted pair cable of claim 4, wherein the conductor portion comprises a first conductor and a second conductor comprising a first twisted pair of conductors, further comprising:
a second conductor portion comprising a second twisted pair of conductors; and
wherein the positioning portion is configured to position the end portions of the barrier portion to substantially equalize crosstalk between the first twisted pair of conductors and to the second twisted pair of conductors.

6. The twisted pair cable of claim 1, wherein the enhanced alien crosstalk mitigation portion is configured to reduce the alien crosstalk by 3 dB or more.

7. A twisted pair cable configured to reduce alien crosstalk from an adjacent twisted pair cable, comprising:
a conductor portion;
an enhanced alien crosstalk mitigation portion that is structurally configured to surround the conductor portion
wherein the enhanced alien crosstalk mitigation portion comprises a barrier portion;
wherein the barrier portion comprises a first end portion and a second end portion configured to extend along a length of the twisted pair cable;
wherein the barrier portion is configured to be wrapped around the conductor portion such that the second end portion is positioned adjacent to and overlaps the first end portion;
wherein the barrier portion includes a folded portion that is folded back toward an outer surface of the barrier portion such that the folded portion includes an inner fold portion and an outer fold portion;
wherein the outer fold portion includes the first end portion; and
wherein the inner fold portion is configured to provide a layer of the barrier portion between the conductor portion and the first and second end portions of the barrier portion so as to reduce alien crosstalk between the twisted pair cable and an adjacent twisted pair cable.

8. The twisted pair cable of claim 7, wherein the barrier portion comprises an inner layer and an outer layer.

9. The twisted pair cable of claim 8, wherein the inner layer comprises a non conductive layer and the outer layer comprises a conductive layer.

10. The twisted pair cable of claim 7, further comprising a positioning portion disposed adjacent to the conductor portion.

11. The twisted pair cable of claim 10, wherein the inner fold portion of the barrier portion is configured to be affixed to the positioning portion such that the barrier portion is fixedly positioned relative to the positioning portion.

12. The twisted pair cable of claim 7, wherein the folded portion is configured in a U shape to provide the additional layer of the barrier portion between the conductor portion and the first and second end portions.

13. The twisted pair cable of claim 7, wherein the folded portion includes a middle fold portion between the inner fold portion and the outer fold portion, wherein the middle portion is configured to provide an additional layer between the conductor portion and the first and second end portions of the barrier portion so as to reduce the alien crosstalk between the twisted pair cable and an adjacent twisted pair cable.

14. The twisted pair cable of claim 13, wherein the folded portion is configured in an S shape to provide the second additional layer of the barrier portion between the conductor portion and the first and second end portions of the barrier portion.

15. The twisted pair cable of claim 7, wherein the conductor portion comprises a first conductor and a second conductor comprising a first twisted pair of conductors, further comprising:
a second conductor portion comprising a second twisted pair of conductors; and
wherein the positioning portion is configured to position the end portions of the barrier portion to substantially equalize crosstalk between the first twisted pair of conductors and to the second twisted pair of conductors.

16. The twisted pair cable of claim 7, wherein the enhanced alien crosstalk mitigation portion is configured to reduce the alien crosstalk by 3 dB or more.

17. A twisted pair cable configured to reduce alien crosstalk from an adjacent twisted pair cable, comprising:
a conductor portion;
an enhanced alien crosstalk mitigation portion;
wherein the enhanced alien crosstalk mitigation portion comprises a first end portion and a second end portion;
wherein the first end portion of the enhanced alien crosstalk mitigation portion includes a folded portion that is folded back toward an outer surface of the enhanced alien crosstalk mitigation portion such that the folded portion includes an inner fold portion and the first end portion; and
wherein the inner fold portion provides a layer of the enhanced alien crosstalk mitigation portion between the first and second end portions of the enhanced alien crosstalk mitigation portion and the conductor portion to reduce alien crosstalk between the twisted pair cable and an adjacent twisted pair cable.

18. The twisted pair cable of claim 17, wherein the enhanced alien crosstalk mitigation portion is structurally configured to surround at least a portion of the conductor portion.

19. The twisted pair cable of claim 17, wherein the enhanced alien crosstalk mitigation portion is configured to be wrapped around the conductor portion such that the first end portion overlaps the second end portion.

20. The twisted pair cable of claim 17, wherein the enhanced alien crosstalk mitigation portion comprises an inner layer and an outer layer.

21. The twisted pair cable of claim 20, wherein the inner layer comprises a non conductive layer and the outer layer comprises a conductive layer.

22. The twisted pair cable of claim 17, further comprising a positioning portion disposed adjacent to the conductor portion.

23. The twisted pair cable of claim 22, wherein the inner fold portion of the enhanced alien crosstalk mitigation portion is configured to be affixed to the positioning portion such that the enhanced alien crosstalk mitigation portion is fixedly positioned relative to the positioning portion.

24. The twisted pair cable of claim 17, wherein the folded portion is configured in a U shape to provide the layer of the enhanced alien crosstalk mitigation portion between the conductor portion and the first and second end portions.

25. The twisted pair cable of claim 17, wherein the folded portion includes a middle fold portion between the inner fold portion and the outer fold portion, wherein the middle fold portion is configured to provide an additional layer of the enhanced alien crosstalk mitigation portion between the conductor portion and the first and second end portions of the enhanced alien crosstalk mitigation portion so as to reduce the alien crosstalk between the twisted pair cable and the adjacent twisted pair cable.

26. The twisted pair cable of claim 25, wherein the folded portion is configured in an S shape to provide the additional layer between the conductor portion and the first and second end portions of the barrier portion.

27. The twisted pair cable of claim 17, wherein the conductor portion comprises a first conductor and a second conductor comprising a first twisted pair of conductors, further comprising:
a second conductor portion comprising a second twisted pair of conductors; and
wherein the positioning portion is configured to position the end portions of the barrier portion to substantially equalize crosstalk between the first twisted pair of conductors and to the second twisted pair of conductors.

28. The twisted pair cable of claim 17, wherein the enhanced alien crosstalk mitigation portion is configured to reduce the alien crosstalk by 3 dB or more.
